(19) United States
(12) Patent Application Publication
(10) Pub. No.: US 2010/0265741 A1
(43) Pub. Date: Oct. 21, 2010

(54) POWER FACTOR CORRECTING CONVERTER

(75) Inventor: Hiroshi USUI, Niiza-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sanken Electric Co., Ltd., Niiza-shi (JP)

(21) Appl. No.: 12/759,985

(22) Filed: Apr. 14, 2010

(30) Foreign Application Priority Data
Apr. 16, 2009 (JP) 2009-100040

(51) Int. Cl. H02M 3/335

(52) U.S. Cl. 363/21.12

(57) ABSTRACT

A power factor correcting converter includes a DC-DC converter to convert a DC voltage, which is formed by rectifying an AC voltage of an AC power source through a rectifier, into a DC voltage of the DC-DC converter and a step-up converter to step up the DC voltage of the DC-DC converter. Secondary windings of a transformer Ta in the DC-DC converter are directly connected to the step-up converter.

### BACKGROUND OF THE INVENTION

1. Field of the Invention

The present invention relates to a power factor correcting converter.

2. Description of the Related Art

FIG. 1 is a circuit diagram illustrating a power factor correcting converter employing a DC-DC converter 1 and a step-up converter 2, according to a related art. A diode bridge DB receives an AC voltage from a commercial power source AC, full-wave-rectifies the AC voltage into a DC voltage, and supplies the DC voltage to the DC-DC converter 1. The DC-DC converter 1 is a half-bridge, full-wave-rectifying current resonant converter in which a series circuit of switching elements Q1 and Q2 of MOSFET is connected to the output of the diode bridge DB.

The switching element Q1 is connected to a voltage resonant capacitor Cry in parallel. Also connected in parallel with the switching element Q1 is a series circuit including a current resonant reactor Lr, a primary winding P of a transformer Ta, and a current resonant capacitor Cri. The transformer Ta has the primary winding P and a series circuit of secondary windings S1 and S2 having a center tap.

Ends of the series circuit of secondary windings S1 and S2 are connected to anodes of diodes D1 and D2. Cathodes of the diodes D1 and D2 are connected to a first end of an output smoothing capacitor C2. A second end of the output smoothing capacitor C2 is connected to the center tap of the secondary windings S1 and S2. Gates of the switching elements Q1 and Q2 are connected to a controller 11.

The output smoothing capacitor C2 is connected to the step-up converter 2. The step-up converter 2 includes a step-up chopper having a reactor Lo, a switching element Q3 of a MOSFET, a diode D3, and an output smoothing capacitor Co. A gate of the switching element Q3 is connected to a controller 13. The controller 13 uses a voltage of a current detecting resistor Rs in a switching current loop and an output voltage V0 of the output smoothing capacitor Co, to turn on/off the switching element Q3.

Operation of the power factor correcting converter of the related art will be explained with reference to FIGS. 2A and 2B. The diode bridge DB full-wave-rectifies an AC voltage from the commercial power source AC into an input voltage Vra, which is supplied to the DC-DC converter 1. The DC-DC converter 1 converts the input voltage Vra into an intermediate voltage V2.

The controller 11 outputs a control signal including a dead time, to alternately turn on/off the switching elements Q1 and Q2 at a switching frequency that is sufficiently higher than a frequency of the commercial power source AC. When the switching element Q2 is turned on, a current passes through a path extending along AC, DB, Q2, Lr, P, Cri, DB, and AC. The current passing at this time includes a first resonant current passing through an exciting inductance Lp of the primary winding P and a second resonant current passing through the primary winding P and secondary winding S2 to the diode D2 and capacitor C2. The first resonant current is observed as a series resonant current waveform produced by a total inductance of the current resonant reactor Lr and exciting inductance Lp and the current resonant capacitor Cri. The second resonant current is observed as a series resonant current ILr produced by the current resonant reactor Lr, exciting inductance Lp, and current resonant capacitor Cri.

Thereafter, the switching element Q2 is turned off. Then, a resonant circuit of the current resonant capacitor Cri, current resonant reactor Lr, exciting inductance Lp, and voltage resonant capacitor Cry acts to gradually decrease the voltage of the voltage resonant capacitor Crv.

When the voltage of the voltage resonant capacitor Cry decreases to 0 V or lower, the switching element Q1 is turned on to achieve zero-voltage switching of the switching element Q1. When the switching element Q1 is turned on, a current passes counterclockwise through a path extending along Cri, P, Lr, Crv, and Cri. This current includes a first resonant current passing through the exciting inductance Lp of the primary winding P and a second resonant current passing through the primary winding P and secondary winding S1 to the diode D1 and capacitor C2. The first resonant current is observed as a series resonant current waveform produced by the total inductance of the current resonant reactor Lr and exciting inductance Lp and the current resonant capacitor Cri. The second resonant current is observed as the series resonant current ILr produced by the current resonant reactor Lr and current resonant capacitor Cri.

Thereafter, the switching element Q1 is turned off. Then, the resonant circuit of the current resonant capacitor Cri, current resonant reactor Lr, exciting inductance Lp, and voltage resonant capacitor Cry acts to gradually increase the voltage of the voltage resonant capacitor Crv.

When the voltage of the voltage resonant capacitor Cry exceeds the input voltage Vra, the switching element Q2 is turned on, to achieve zero-voltage switching of the switching element Q2. Thereafter, the above-mentioned operations are repeated as illustrated in FIG. 2B. In FIG. 2B, the series resonant current is observed. The series resonant current produced by the total inductance of the current resonant reactor Lr and exciting inductance Lp and the current resonant capacitor Cri is constant irrespective of load. If a setting is made not to zero a current when the switching elements Q1 and Q2 are OFF, quasi-voltage-resonance will be realized when the switching elements Q1 and Q2 are OFF, as illustrated in FIG. 2B.

In this way, the DC-DC converter 1 carries out the current resonance and quasi-voltage-resonance, to realize the zero-voltage switching and zero-current switching, thereby minimizing a switching loss, improving efficiency, and reducing noise.

The step-up converter 2 receives the intermediate voltage V2 as an input voltage and steps up the same into the constant output voltage V0. The controller 13 uses the current detecting resistor Rs to observe an input current and turns on/off the switching element Q3 so that the input current may resemble the waveform of the input voltage.

When the switching element Q3 is turned on, a current passes counterclockwise through a path extending along C2, Lo, Q3, Rs, and C2, to accumulate energy in the reactor Lo. When the switching element Q3 is turned off, a voltage VLo generated by the energy accumulated in the reactor Lo is added to the voltage V2 and the sum is rectified and smoothed through the diode D3 and output smoothing capacitor Co and is supplied as the output voltage V0 to a load.

When the switching elements Q1 and Q2 are OFF, the output smoothing capacitor C2 prevents a current passing through the diodes D1 and D1, thereby the secondary windings S1 and S2 are open. Namely, the smoothing capacitor C2 is a capacitor to interpolate an interval between switching periods of the switching elements Q1 and Q2. Capacitance of the capacitor C2 is sufficiently small with respect to the frequency of the commercial power source AC. Accordingly, unlike a current waveform provided by a standard capacitor-input rectifier, the input current waveform Iin takes a sinusoidal waveform as illustrated in FIG. 2A, thereby correcting a power factor.

In this way, combining the high-efficiency, low-noise resonant DC-DC converter and the step-up chopper provides a high-efficiency, low-noise power factor correcting converter. The power factor correcting converter may employ an insulated DC-DC converter, to provide an insulated power factor correcting circuit.

### SUMMARY OF THE INVENTION

The insulated power factor correcting converter according to the related art, however, employs the two-stage configuration, to increase the number of parts and costs.

The present invention provides an insulated power factor correcting converter at low cost.

According to an aspect of the present invention, the power factor correcting converter includes a DC-DC converter having a transformer to convert a DC voltage, which is formed by rectifying an AC voltage of an AC power source through a rectifier, into a DC voltage of the DC-DC converter and a step-up converter to step up the DC voltage of the DC-DC converter. A secondary winding of the transformer in the DC-DC converter is directly connected to the step-up converter.

### BRIEF DESCRIPTION OF THE DRAWINGS

FIG. 1 is a circuit diagram illustrating a power factor correcting converter according to a related art;

FIGS. 2A and 2B illustrate waveforms at various parts of the power factor correcting converter of FIG. 1;

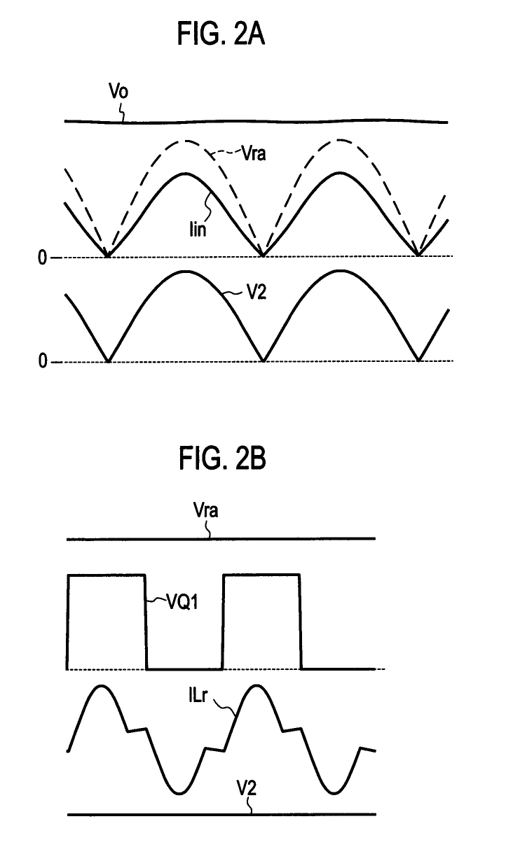

FIG. 3 is a circuit diagram illustrating a power factor correcting converter according to Embodiment 1 of the present invention;

FIGS. 4A and 4B illustrate waveforms at various parts of the power factor correcting converter of FIG. 3;

FIG. 5 is a circuit diagram illustrating a voltage detector of a controller 12 in the power factor correcting converter of FIG. 3;

FIG. 6 is a circuit diagram illustrating a power factor correcting converter according to Embodiment 2 of the present invention;

FIG. 7 is a circuit diagram illustrating a power factor correcting converter according to Embodiment 3 of the present invention;

FIG. 8 is a circuit diagram illustrating a power factor correcting converter according to Embodiment 4 of the present invention;

FIGS. 9A and 9B illustrate waveforms at various parts of the power factor correcting converter of FIG. 8;

FIG. 10 is a circuit diagram illustrating a power factor correcting converter according to Embodiment 5 of the present invention;

FIG. 11 is a circuit diagram illustrating a power factor correcting converter according to Embodiment 6 of the present invention;

FIG. 12 is a circuit diagram illustrating a power factor correcting converter according to Embodiment 7 of the present invention; and

FIG. 13 is a circuit diagram illustrating a power factor correcting converter according to Embodiment 8 of the present invention;

### DESCRIPTION OF THE PREFERRED EMBODIMENT

Power factor correcting converters according to embodiments of the present invention will be explained in detail with reference to the drawings.

### Embodiment 1

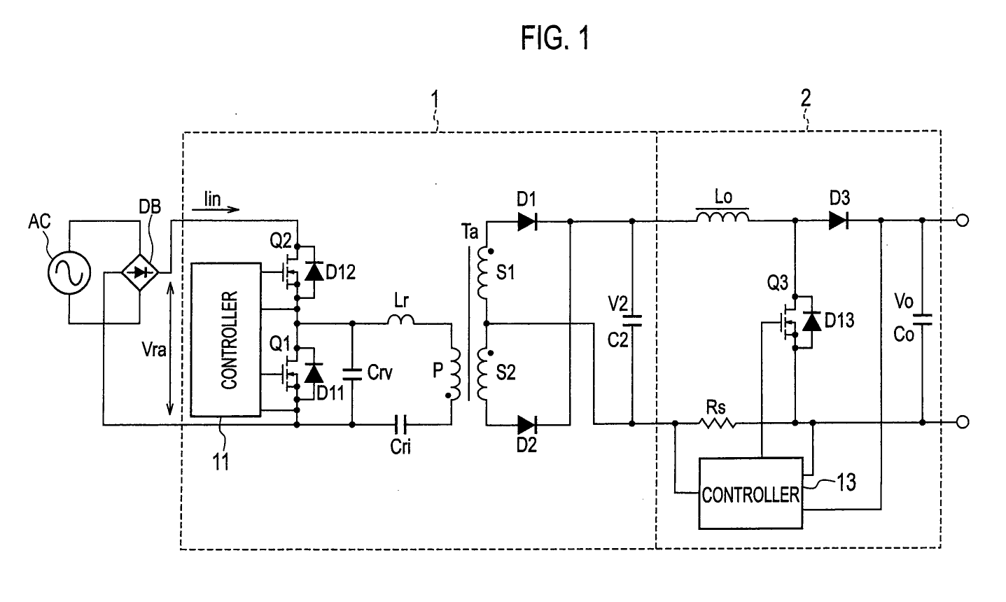

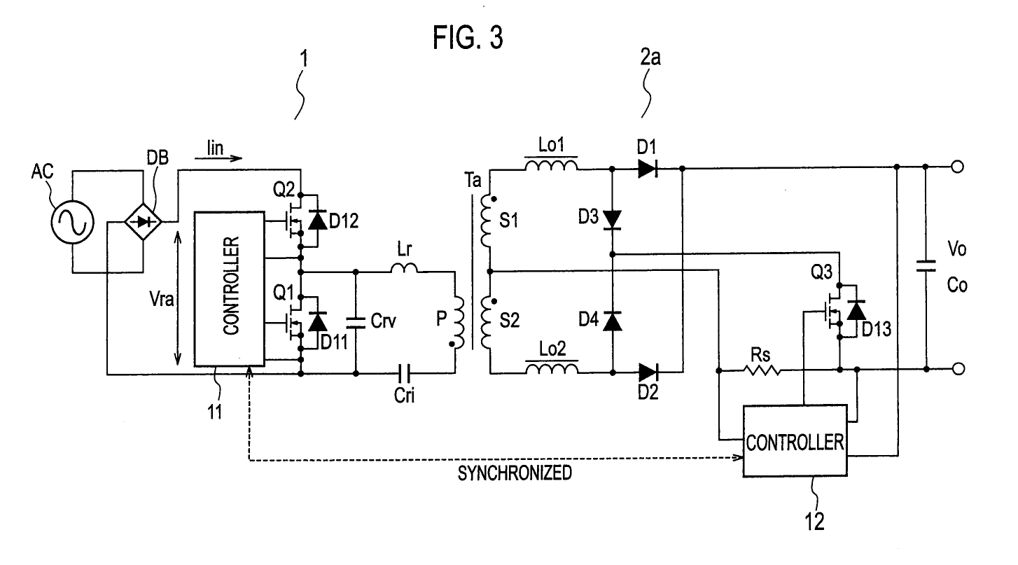

FIG. 3 is a circuit diagram illustrating a power factor correcting converter according to Embodiment 1 of the present invention. In FIG. 3, the same elements as those of the related art of FIG. 1 are represented with the same reference marks. Embodiment 1 of FIG. 3 differs from the related art of FIG. 1 in the secondary side of a transformer Ta, and therefore, this part will mainly be explained.

A commercial power source AC is insulated through a DC-DC converter 1 from an output terminal to which an output smoothing capacitor Co is connected.

In a step-up converter 2a, a first end of a reactor Lo1 is connected to a first end of a series circuit of secondary windings S1 and S2 of the transformer Ta. A second end of the series circuit of secondary windings S1 and S2 is connected to a first end of a reactor Lo2.

A second end of the reactor Lo1 is connected to an anode of a diode D1 and an anode of a reverse-current-preventive diode D3. A second end of the reactor Lo2 is connected to an anode of a diode D2 and an anode of a reverse-current-preventive diode D4. Cathodes of the diodes D1 and D2 are connected to each other and to a first end of the output smoothing capacitor Co, i.e., the output terminal. Cathodes of the reverse-current-preventive diodes D3 and D4 are connected to a drain of a switching element Q3.

A source of the switching element Q3 is connected to a second end of the output smoothing capacitor Co and through a current detecting resistor Rs to a connection point of the secondary windings S1 and S2 of the transformer Ta. A controller 11 fixes an ON/OFF ratio of switching elements Q1 and Q2 within a half period of an AC voltage of the commercial power source AC and alternately turns on/off the switching elements Q1 and Q2. A controller 12 turns on/off the switching element Q3 according to an output voltage V0 and a voltage proportional to a current passing through the current detecting resistor Rs.

The controller 12 turns on/off the switching element Q3 in synchronization with the turning on/off of the switching elements Q1 and Q2. Such a synchronization is achievable according to, for example, a winding voltage of the secondary winding S1 (S2). This results in synchronizing the DC-DC converter 1 and step-up converter 2a with each other.

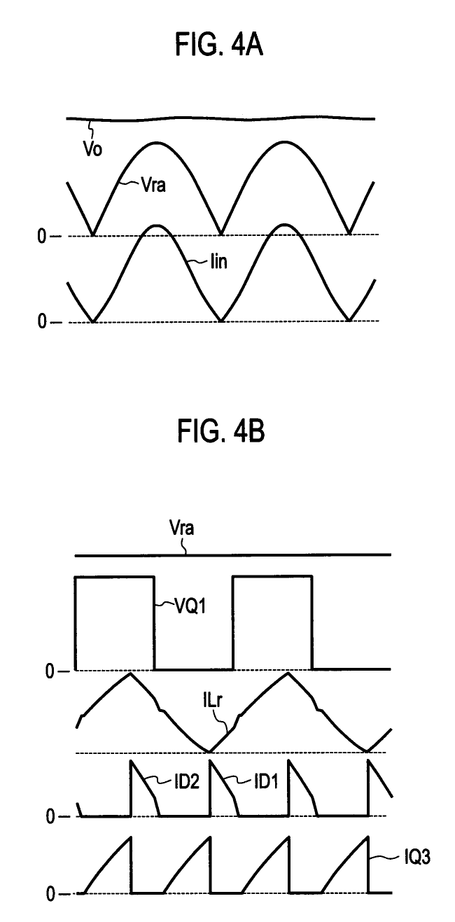

Operation of the power factor correcting converter according to the present embodiment will be explained with reference to FIGS. 4A and 4B. When the switching element Q2 is turned on, a current ILr passes through a path extending along AC, DB, Q2, Lr, P, Cri, DB, and AC. At this time, a current passes through the primary winding P and secondary winding S2 of the transformer Ta to the secondary side. If the switching element Q3 is ON, a current IQ3 passes through a path extending along S2, Lo2, D4, Q3, Rs, and S2, to accumulate energy in the reactor Lo2.

If the switching element Q3 is OFF, a current ID2 passes through a route extending along Lo2, D2, Co, Rs, S2, and Lo2, to supply the output voltage V0 through the output smoothing capacitor Co to a load.

Consequently, a resonant current on the primary side of the transformer Ta is observed as (i) a series resonant current waveform produced by a total inductance of the current resonant reactor Lr and exciting inductance Lp and the current resonant capacitor Cri and (ii) a series resonant current produced by the current resonant reactor Lr, current resonant capacitor Cri, and equivalent reactor Lo2 as converted by turn ratio.

Thereafter, the switching element Q2 is turned off. Then, a resonant circuit of the current resonant capacitor Cri, current resonant reactor Lr, exciting inductance Lp, and voltage resonant capacitor Cry acts to gradually decrease the voltage of the voltage resonant capacitor Crv.

When the voltage of the voltage resonant capacitor Cry decreases to 0 V or lower, the switching element Q1 is turned on, to realize zero-voltage switching of the switching element Q1. When the switching element Q1 is turned on, the current ILr passes counterclockwise through a path extending along Cri, P, Lr, Crv, and Cri.

If the switching element Q3 is ON, the current IQ3 passes clockwise through a path extending along S1, Lo1, D3, Q3, Rs, and S1, to accumulate energy in the reactor Lo1. If the switching element Q3 is OFF, a current ID1 passes clockwise through a path extending along Lo1, D1, Co, Rs, S1, and Lo1, to supply the output voltage V0 through the output smoothing capacitor Co to the load.

Consequently, a resonant current on the primary side of the transformer Ta is observed as a series resonant current waveform produced by the total inductance of the current resonant reactor Lr and exciting inductance Lp and the current resonant capacitor Cri and a series resonant current produced by the current resonant reactor Lr, current resonant capacitor Cri, and equivalent reactor Lo1 as converted by turn ratio.

Thereafter, the switching element Q1 is turned off. Then, the resonant circuit of the current resonant capacitor Cri, exciting inductance Lp, current resonant reactor Lr, and voltage resonant capacitor Cry acts to gradually increase the voltage of the voltage resonant capacitor Crv. When the voltage of the voltage resonant capacitor Cry exceeds a power source voltage Vra, the switching element Q2 is turned on, to realize zero-voltage switching of the switching element Q2. Thereafter, the above-mentioned operations are repeated.

FIG. 4B illustrates the above-mentioned operations. The series resonant current is observed as a triangular-wave current of part of a sinusoidal wave because the inductance is relatively large and the resonant frequency is lower than a switching frequency.

The primary-side series resonant current produced by the total inductance of the current resonant reactor Lr and exciting inductance Lp and the current resonant capacitor Cri is constant irrespective of load. If a setting is made not to zero a current when the switching elements Q1 and Q2 are OFF, quasi-voltage-resonance will be realized when the switching elements Q1 and Q2 are OFF, as illustrated in FIG. 4B.

In this way, the primary side carries out the current resonance and quasi-voltage-resonance, to realize the zero-voltage switching and zero-current switching, thereby minimizing a switching loss, improving efficiency, and reducing noise.

The controller 12 controls the output voltage V0 to a predetermined value by turning on/off the switching element Q3 in synchronization with the turning on/off of the switching elements Q1 and Q2. This control opens the secondary windings S1 and S2 when the switching elements Q1 and Q2 are OFF. The controller 12 observes an input current passing through the current detecting resistor Rs and turns on/off the switching element Q3 so that the input current may resemble an input voltage waveform.

The power factor correcting converter of the present embodiment omits the capacitor C2 of the related art of FIG. 1. The input current waveform Iin is sinusoidal as illustrated in FIG. 4A, to correct a power factor. In this way, the power factor correcting converter according to the present embodiment works without the capacitor C2, minimizes a switching loss, improves efficiency, reduces noise, and is manufacturable at low cost.

The controller 12 turns on/off the switching element Q3 according to a switching current passing through the current detecting resistor Rs. The detector for detecting the switching current is omissible if an ON period of the switching element Q3 is substantially fixed within a half period of a frequency of the AC voltage of the commercial power source AC. In this case, the controller 12 carries out PWM control on the switching element Q3 to keep the output voltage V0 constant with a feedback response time being equal to or larger than half a period of the frequency of the commercial power source AC.

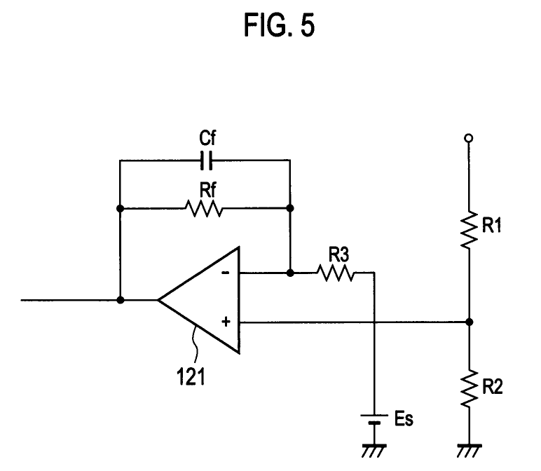

FIG. 5 is a circuit diagram illustrating a voltage detector of the controller 12 in the power factor correcting converter according to the present embodiment. In FIG. 5, the controller 12 includes a series circuit of resistors R1 and R2 connected between the first end of the output smoothing capacitor Co and the ground. A connection point of the resistors R1 and R2 is connected to a non-inverting input terminal of an error amplifier 121. Connected between an inverting input terminal of the error amplifier 121 and the ground is a series circuit of a resistor R3 and a reference power source Es. Connected between the inverting input terminal of the error amplifier 121 and an output terminal thereof is a parallel circuit of a resistor Rf and a capacitor Cf.

A time constant determined by the resistor R3 and capacitor Cf corresponds to the feedback response time and is set to be equal to or larger than a half period of the frequency of the commercial power source AC.

In this way, the power factor correcting converter according to Embodiment 1 omits the capacitor C2 of FIG. 1. Embodiment 1 achieves the current resonance and quasi-voltage-resonance, to realize the zero-voltage switching and zero-current switching. Consequently, the power factor correcting converter according to Embodiment 1 minimizes a switching loss, improves efficiency, reduces noise, and is manufacturable at low cost.

### Embodiment 2

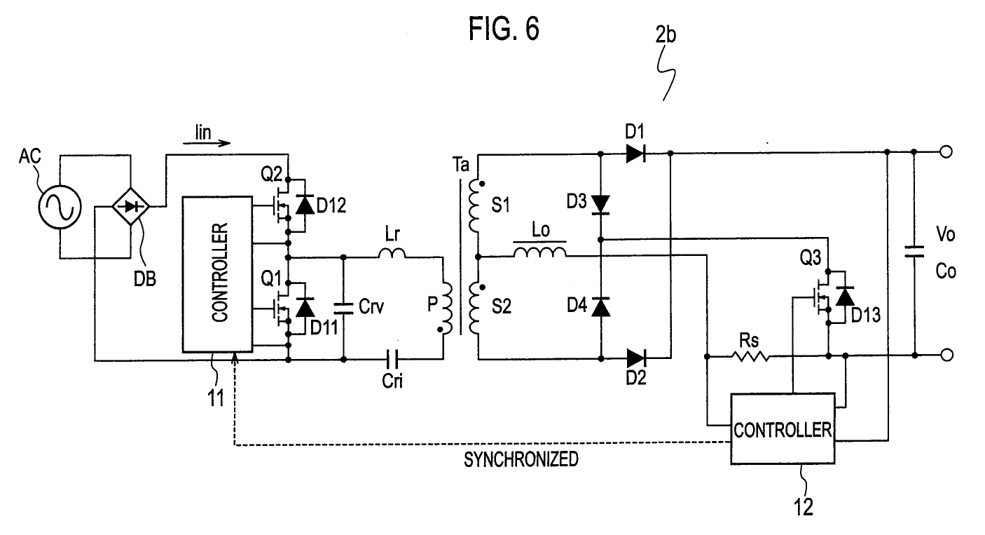

FIG. 6 is a circuit diagram illustrating a power factor correcting converter according to Embodiment 2 of the present invention. Unlike Embodiment 1 of FIG. 3 that employs the reactors Lo1 and Lo2, that is, Embodiment 2 of FIG. 6 employs a reactor Lo connected to a connection point of secondary windings S1 and S2 of a transformer Ta, to form a step-up converter 2b. Operation of Embodiment 2 is substantially the same as that of Embodiment 1. With the use of only one reactor Lo, the power factor correcting converter of Embodiment 2 is manufacturable at lower cost.

### Embodiment 3

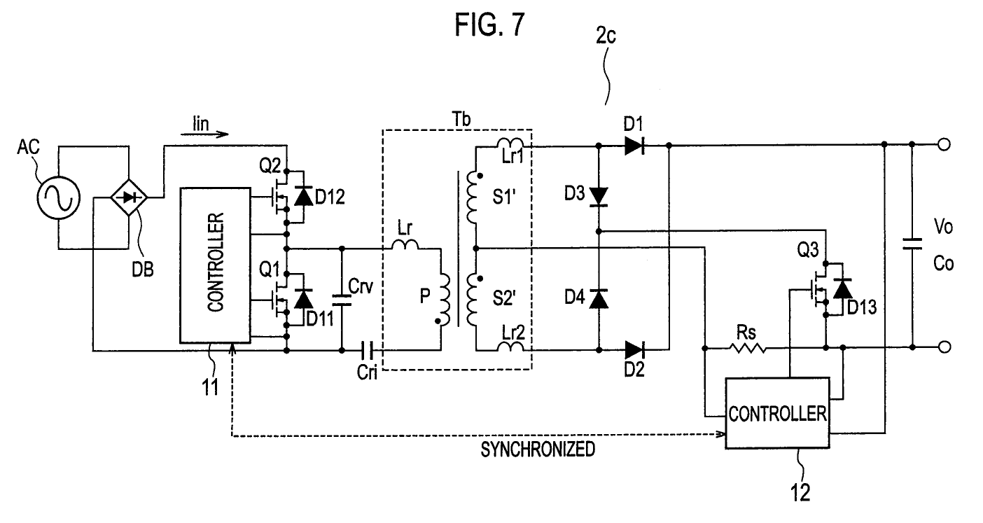

FIG. 7 is a circuit diagram illustrating a power factor correcting converter according to Embodiment 3. Instead of the reactors Lo1 and Lo2 of Embodiment 1 of FIG. 3, a step-up converter 2c according to Embodiment 3 of FIG. 7 employs a leakage inductance between a primary winding P and secondary windings S1′ and S2′ of a transformer Tb. The leakage inductance is expressible in many ways in a circuit diagram. In FIG. 7, the leakage inductance is expressed as Lr1 and Lr2 for the sake of convenience. Embodiment 3 provides substantially the same effect as Embodiment 1 of FIG. 3. By employing the leakage inductance (Lr1, Lr2) of the transformer Tb instead of the reactors Lo1 and Lo2 of Embodiment 1, the power factor correcting converter according to Embodiment 3 is manufacturable at lower cost.

### Embodiment 4

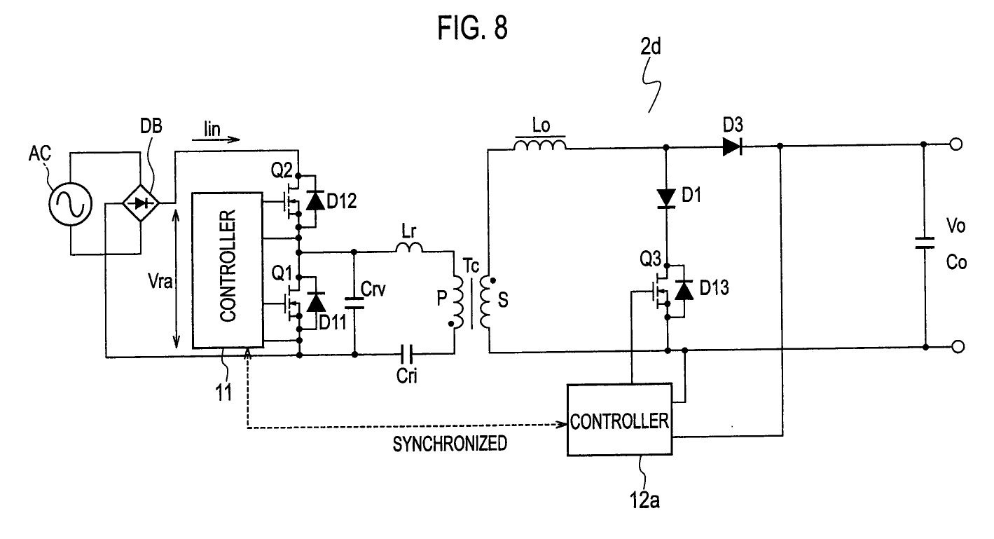

FIG. 8 is a circuit diagram illustrating a power factor correcting converter according to Embodiment 4 of the present invention. In a step-up converter 2d of FIG. 8, a first end of a secondary winding S of a transformer Tc is connected through a reactor Lo to anodes of diodes D1 and D3. A cathode of the diode D1 is connected to a drain of a switching element Q3. A cathode of the diode D3 is connected to a first end of an output smoothing capacitor Co. A second end of the output smoothing capacitor Co is connected to a source of the switching element Q3 and a second end of the secondary winding S.

The step-up converter 2d employs no current detecting resistor Rs. In place of the DC-DC converter 1, Embodiment 4 employs a half-bridge, half-wave-rectifying current resonant converter.

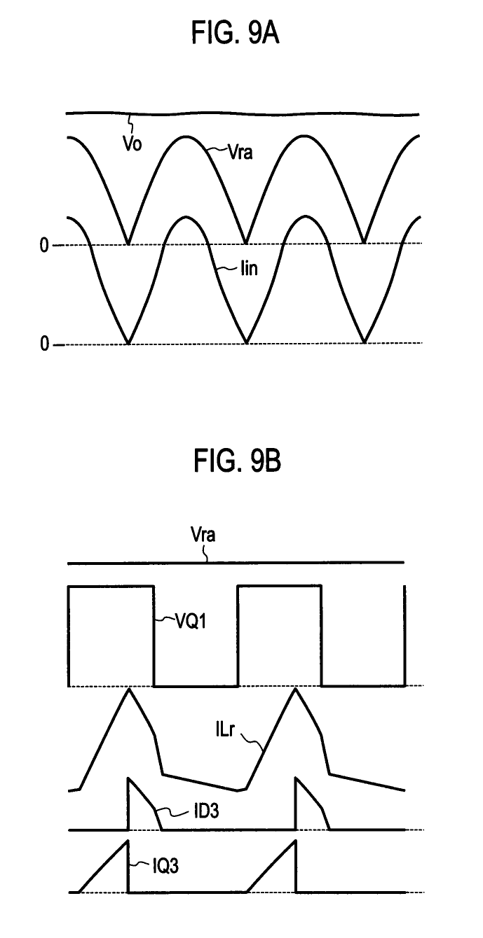

Operation of the power factor correcting converter according to Embodiment 4 will be explained with reference to FIGS. 9A and 9B. The half-bridge, half-wave-rectifying current resonant converter allows an ON/OFF ratio of switching elements Q1 and Q2 to be optionally adjusted.

When the switching element Q2 is turned on, a current ILr passes through a path extending along AC, DB, Q2, Lr, P, Cri, DB, and AC. At this time, the diodes D1 and D3 are reversely biased not to pass a current through the secondary side of the transformer Tc.

A resonant current on the primary side of the transformer Tc is observed as a series resonant current waveform produced by the total inductance of the current resonant reactor Lr and exciting inductance Lp and the current resonant capacitor Cri.

Thereafter, the switching element Q2 is turned off. Then, a resonant circuit of the current resonant capacitor Cri, exciting inductance Lp, current resonant reactor Lr, and voltage resonant capacitor Cry acts to gradually decrease the voltage of the voltage resonant capacitor Cry. When the voltage of the voltage resonant capacitor Cry decreases to 0 V or lower, the switching element Q1 is turned on, to achieve zero-voltage switching of the switching element Q1.

When the switching element Q1 is turned on, the current ILr passes counterclockwise through a path extending along Cri, P, Lr, Crv, and Cri. If the switching element Q3 is ON, a current IQ3 passes through the primary winding P of the transformer Tc through a path extending along S, Lo, D1, Q3, and S, to accumulate energy in the reactor Lo.

If the switching element Q3 is OFF, a current ID3 passes clockwise through a path extending along Lo, D3, Co, S, and Lo, to supply an output voltage V0 through the output smoothing capacitor Co to a load.

In this way, a resonant current on the primary side is observed as a series resonant current waveform produced by the total inductance of the current resonant reactor Lr and exciting inductance Lp and the current resonant capacitor Cri and a series resonant current produced by the current resonant reactor Lr, current resonant capacitor Cri, and equivalent reactor Lo as converted by turn ratio.

Thereafter, the switching element Q1 is turned off. Then, a resonant circuit of a combined reactor of the current resonant capacitor Cri, current resonant reactor Lr, and exciting inductance Lp and the voltage resonant capacitor Cry acts, to gradually increase the voltage of the voltage resonant capacitor Cry. When the voltage of the voltage resonant capacitor Cry exceeds a voltage Vra, the switching element Q2 is turned on, to achieve zero-voltage switching of the switching element Q2. Thereafter, the above-mentioned operations are repeated.

FIG. 9B illustrates these operations. Although the series resonant current passes, it is observed as a triangular wave current as part of a sinusoidal wave because the inductance is relatively large and the resonant frequency is lower than a switching frequency.

The primary-side series resonant current produced by the total inductance of the current resonant reactor Lr and exciting inductance Lp and the current resonant capacitor Cri is constant without regard to load. If a setting is made not to zero a current when the switching elements Q1 and Q2 are OFF, quasi-voltage-resonance will be realized when the switching elements Q1 and Q2 are OFF, as illustrated in FIG. 9B. In this way, the primary side achieves the current resonance and quasi-voltage-resonance, to realize the zero-voltage switching and zero-current switching, thereby minimizing a switching loss, improving efficiency, and reducing noise.

To control the output voltage V0 to a predetermined value, a controller 12a carries out PWM control on the switching element Q3 in synchronization with the turning on/off of the switching elements Q1 and Q2. This results in opening the secondary winding S when the switching elements Q1 and Q2 are OFF. A feedback response time of the PWM control is set to be equal to or longer than a half period of a frequency of the commercial power source AC. Namely, a control pulse width for the switching element Q3 is constant within a half period of the frequency of the commercial power source AC.

Consequently, the power factor correcting converter according to Embodiment 4 omits the capacitor C2 of FIG. 1. According to Embodiment 4, an input current waveform Iin is sinusoidal as illustrated in FIG. 9A to improve a power factor. In this way, the power factor correcting converter of Embodiment 4 employs no capacitor C2 of FIG. 1, minimizes a switching loss, improves efficiency, and reduces noise.

### Embodiment 5

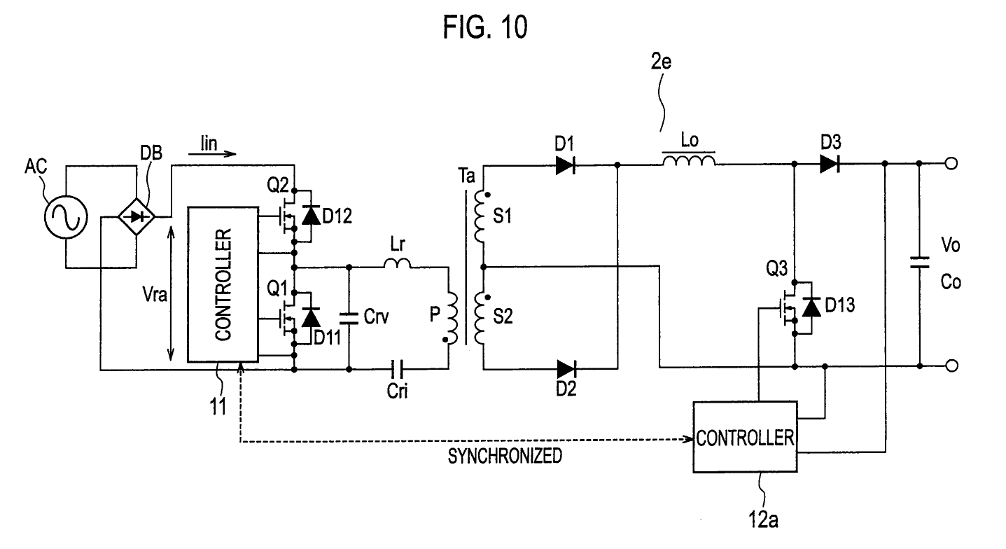

FIG. 10 is a circuit diagram illustrating a power factor correcting converter according to Embodiment 5 of the present invention. Embodiment 5 connects a first end of a secondary winding S1 of a transformer Ta to an anode of a diode D1 and a first end of a secondary winding S2 of the transformer Ta to an anode of a diode D2. Cathodes of the diodes D1 and D2 are connected through a reactor Lo to an anode of a diode D3 and a drain of a switching element Q3. A cathode of the diode D3 is connected to a first end of an output smoothing capacitor Co. A second end of the output smoothing capacitor Co is connected to a source of the switching element Q3 and a connection point of the secondary windings S1 and S2.

A step-up converter 2e of Embodiment 5 operates like the step-up converter 2a of Embodiment 1 of FIG. 3. Embodiment 5 uses the reactor Lo and three diodes D1, D2, and D3, to provide the same effect as Embodiment 1 at lower cost.

### Embodiment 6

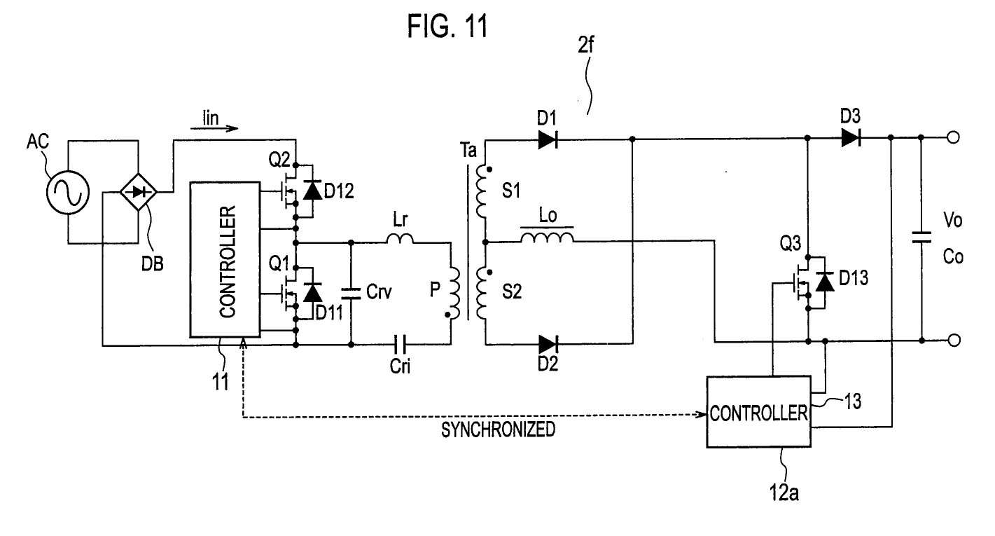

FIG. 11 is a circuit diagram illustrating a power factor correcting converter according to Embodiment 6 of the present invention. Compared with the step-up converter 2b of Embodiment 2 of FIG. 6, a step-up converter 2f of Embodiment 6 of FIG. 11 omits the diodes D3 and D4 of FIG. 6 and connects cathodes of diodes D1 and D2 to an anode of a diode D3 and a drain of a switching element Q3. A cathode of the diode D3 is connected to a first end of an output smoothing capacitor Co.

The step-up converter 2f of Embodiment 6 operates like the step-up converter 2b of Embodiment 2. With the use of the three diodes D1, D2, and D3, Embodiment 6 provides an effect similar to the effect of Embodiment 2 at lower cost.

### Embodiment 7

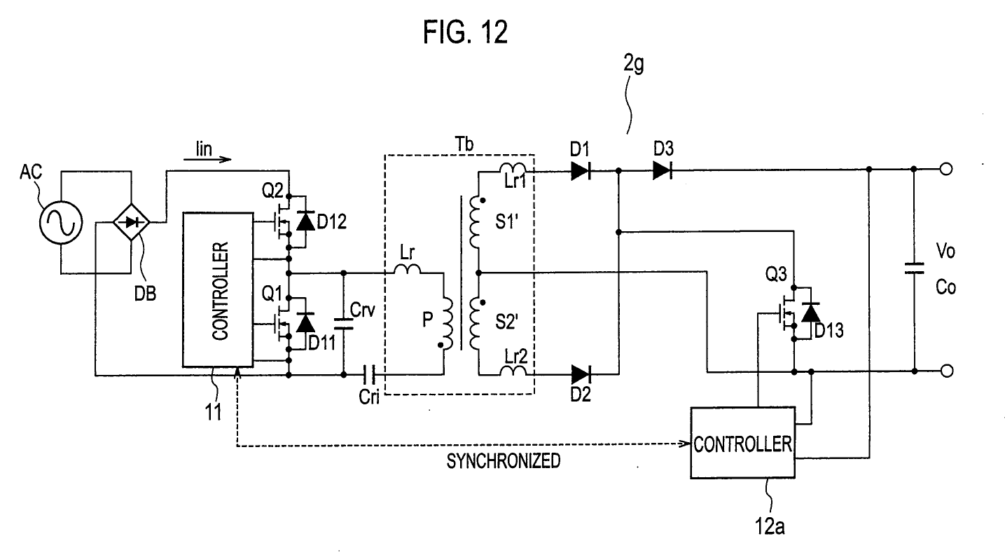

FIG. 12 is a circuit diagram illustrating a power factor correcting converter according to Embodiment 7 of the present invention. Compared with Embodiment 3 of FIG. 7, a step-up converter 2g of Embodiment 7 in FIG. 12 omits the diodes D3 and D4 and current detecting resistor Rs of FIG. 7 and connects cathodes of diodes D1 and D2 to an anode of a diode D3 and a drain of a switching element Q3. A cathode of the diode D3 is connected to a first end of an output smoothing capacitor Co.

The step-up converter 2g of Embodiment 7 operates like the step-up converter 2c of Embodiment 3. With the use of the three diodes D1, D2, and D3, the power factor correcting converter of Embodiment 7 substantially provides the same effect as Embodiment 3 at lower cost.

### Embodiment 8

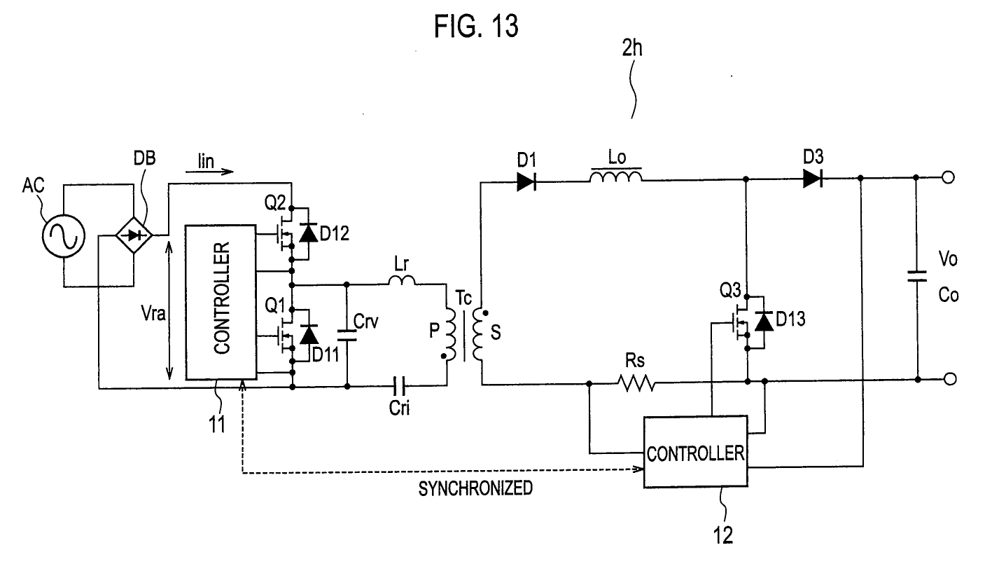

FIG. 13 is a circuit diagram illustrating a power factor correcting converter according to Embodiment 8 of the present invention. Compared with the step-up converter 2d of Embodiment 4 in FIG. 8, a step-up converter 2h of Embodiment 8 in FIG. 13 arranges a diode D1 between a secondary winding S of a transformer Tc and a reactor Lo. Embodiment 8 operates like Embodiment 4, to substantially provide the same effect as Embodiment 4 at lower cost.

As explained above, the present invention directly connects a secondary winding of a transformer in a DC-DC converter to a step-up converter, thereby providing an integrated configuration. Without an intermediate capacitor between the DC-DC converter and the step-up converter, the present invention constitutes an insulated power factor correcting converter at low cost.

The present invention is applicable to power factor correcting converters having a DC-DC converter and a step-up converter.

This application claims benefit of priority under 35 USC §119 to Japanese Patent Application No. 2009-100040, filed on Apr. 16, 2009, the entire contents of which are incorporated by reference herein. Although the invention has been described above by reference to certain embodiments of the invention, the invention is not limited to the embodiments described above. Modifications and variations of the embodiments described above will occur to those skilled in the art, in light of the teachings. The scope of the invention is defined with reference to the following claims.

What is claimed is:

1. A power factor correcting converter comprising:
a DC-DC converter having a transformer, configured to convert a DC voltage, which is formed by rectifying an AC voltage of an AC power source through a rectifier, into a DC voltage of the DC-DC converter; and
a step-up converter configured to step up the DC voltage of the DC-DC converter, wherein
a secondary winding of the transformer of the DC-DC converter is directly connected to the step-up converter.

2. The power factor correcting converter according to claim 1, wherein
the step-up converter employs, as a step-up reactor, a leakage inductance of the transformer in the DC-DC converter.

3. The power factor correcting converter according to claim 1, wherein the step-up converter includes:
a rectifying-smoothing circuit being connected to the secondary winding of the transformer and including at least one reactor and at least one rectifying element;
an output smoothing capacitor connected to an output of the rectifying-smoothing circuit;
a chopper switching element having a first end connected to the at least one rectifying element and a second end connected to one of the secondary winding or at least one reactor; and
a chopper controller configured to control an ON/OFF ratio of the chopper switching element in such a way as to provide a switching current proportional to an output voltage of the DC-DC converter, the chopper controller having a feedback response time that is equal to or longer than a half period of a frequency of the AC power source.

4. The power factor correcting converter according to claim 2, wherein the step-up converter includes:
a rectifying-smoothing circuit being connected to the secondary winding of the transformer and including at least one reactor and at least one rectifying element;
an output smoothing capacitor connected to an output of the rectifying-smoothing circuit;
a chopper switching element having a first end connected to the at least one rectifying element and a second end connected to one of the secondary winding or at least one reactor; and
a chopper controller configured to control an ON/OFF ratio of the chopper switching element in such a way as to provide a switching current proportional to an output voltage of the DC-DC converter, the chopper controller having a feedback response time that is equal to or longer than a half period of a frequency of the AC power source.

5. The power factor correcting converter according to claim 1, wherein the DC-DC converter includes:
a first series circuit having a plurality of switch elements and connected in series with output ends of the rectifier;
a voltage resonant capacitor connected in parallel with one of the plurality of switch elements;
a second series circuit connected in parallel with the one switch element and having a current resonant reactor, a primary winding of the transformer, and a current resonant capacitor; and
a controller configured to fix an ON/OFF ratio of the plurality of switch elements within a half period of the AC voltage of the AC power source and alternately turn on/off the plurality of switch elements.

6. The power factor correcting converter according to claim 2, wherein the DC-DC converter includes:
a first series circuit having a plurality of switch elements and connected in series with output ends of the rectifier;
a voltage resonant capacitor connected in parallel with one of the plurality of switch elements;
a second series circuit connected in parallel with the one switch element and having a current resonant reactor, a primary winding of the transformer, and a current resonant capacitor; and
a controller configured to fix an ON/OFF ratio of the plurality of switch elements within a half period of the AC voltage of the AC power source and alternately turn on/off the plurality of switch elements.

7. The power factor correcting converter according to claim 5, wherein
the chopper controller turns on/off the chopper switching element in synchronization with the ON/OFF timing of the plurality of switch elements.

8. The power factor correcting converter according to claim 6, wherein
the chopper controller turns on/off the chopper switching element in synchronization with the ON/OFF timing of the plurality of switch elements.
